(19) United States
(12) Patent Application Publication
(10) Pub. No.: US 2010/0209764 A1
(43) Pub. Date: Aug. 19, 2010

(54) METHOD OF MANUFACTURING SECONDARY BATTERY, AND SECONDARY BATTERY MANUFACTURED BY THE METHOD

(75) Inventors: Sangdo Heo, Suwon-si (KR); Youngu Kim, Suwon-si (KR); Kyungwon Seo, Suwon-si (KR); Kisung Hong, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/692,799

(22) Filed: Jan. 25, 2010

(30) Foreign Application Priority Data
Feb. 18, 2009 (KR) 10-2009-13483

(51) Int. Cl. H01M 2/02; B29C 45/14

(52) U.S. Cl. 429/163; 264/272.21

(57) ABSTRACT

A method of manufacturing a secondary battery, including: loading a core pack in a cavity of a mold; loading the mold on a mold receiving portion of an injection molding apparatus; and filling a molten resin in a chamber of the mold.

### CROSS-REFERENCE TO RELATED APPLICATION

This application claims the benefit of Korean Application No. 10-2009-0013483, filed Feb. 18, 2009, in the Korean Intellectual Property Office, the disclosure of which is incorporated herein, by reference.

### BACKGROUND

1. Field

The present teachings relate to a secondary battery and a manufacturing method thereof.

2. Description of the Related Art

According to a method of manufacturing a polymer secondary battery, a core pack including a pouch-shaped bare cell and a protection circuit module (PCM) is molded into the secondary battery by injection molding, using a hot-melt resin. In this case, a core pack is inserted and held at a fixed position in a small cavity formed in an injection molding apparatus. However, since a pouch-shaped bare cell is not fixedly connected to a protection circuit module, the insertion and holding of a core pack, at a fixed position in an injection molding apparatus, make the entire battery fabrication process complicated and time-consuming, due to a higher possibility of miss-insertion of the core pack, thereby reducing the quality and productivity of battery products.

### SUMMARY

The present teachings provide a method of manufacturing a high quality secondary battery with a high productivity.

The present teachings also provide a high quality secondary battery manufactured by the method.

According to an aspect of the present teachings, there is provided a method of manufacturing a secondary battery, the method including: loading a core pack in a chamber of a mold; loading the mold on a mold receiving portion of an injection molding apparatus; and filling a molten resin into the chamber of the mold.

According to an aspect of the present teachings, the mold may be made of a plastic material, particularly preferably a thermosetting resin. The mold may be made of Bakelite or Teflon. The resin may be a hot-melt resin.

According to an aspect of the present teachings, the loading of the core pack in the chamber of the mold may include: placing the core pack in a first cavity formed in a first molding block; and coupling the first molding block to a second molding block having a second cavity corresponding to the first cavity. The coupling of the first molding block and the second molding block may be performed by inserting coupling protrusions formed in the second molding block, into coupling holes formed in the first molding block.

According to an aspect of the present teachings, the mold may have two or more chambers.

According to an aspect of the present teachings, the loading of the mold on the mold receiving portion of the injection molding apparatus may be performed by a removable fastening member.

According to an aspect of the present teachings, the core pack may include a pouch-shaped bare cell and a protection circuit module connected to the bare cell. The bare cell may be a lithium polymer battery.

According to another aspect of the present teachings, provided is a secondary battery manufactured by the above-described method.

Additional aspects and/or advantages of the present teachings will be set forth in part in the description which follows and, in part, will be obvious from the description, or may be learned by practice of the present teachings.

### BRIEF DESCRIPTION OF THE DRAWINGS

These and/or other aspects and advantages of the present teachings will become apparent and more readily appreciated from the following description of the exemplary embodiments, taken in conjunction with the accompanying drawings, of which:

FIG. 1 is a flow diagram illustrating a method of manufacturing a secondary battery, according to an exemplary embodiment of the present teachings;

FIG. 2 is a perspective view illustrating the loading of a core pack into a mold of FIG. 1;

FIG. 3 is a sectional view illustrating a mold with a core pack inserted therein;

FIG. 4 is a perspective view illustrating the loading of a mold in an injection molding apparatus;

FIG. 5 is a perspective view illustrating an assembled view of the injection molding apparatus of FIG. 4; and

FIG. 6 is a perspective view of a secondary battery produced by a secondary battery manufacturing method, according to an exemplary embodiment of the present teachings.

### DETAILED DESCRIPTION

Reference will now be made in detail to the exemplary embodiments of the present teachings, examples of which are illustrated in the accompanying drawings, wherein like reference numerals refer to the like elements throughout. The exemplary embodiments are described below, in order to explain the aspects of present teachings, by referring to the figures.

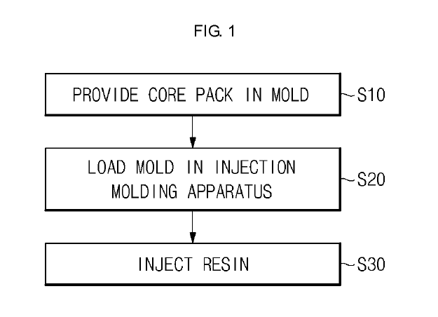

FIG. 1 is a flow diagram illustrating a method of manufacturing a secondary battery, according to an exemplary embodiment of the present teachings. Referring to FIG. 1, the method includes: loading a core pack into a mold (S10); loading the mold in an injection molding apparatus (S20); and injecting a molten resin in a chamber of the mold (S30).

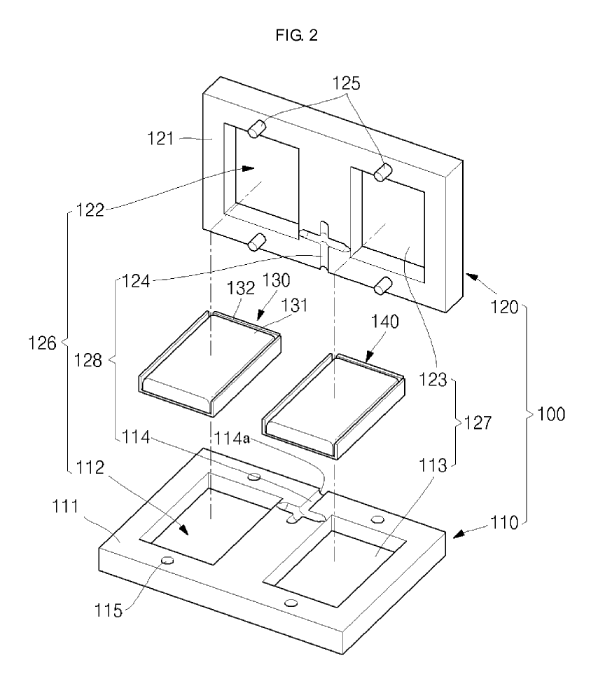

The loading of the core pack into the mold (S10) includes inserting a core pack in a cavity of a mold, which is detached from an injection molding apparatus. The mold will be first described with reference to FIG. 2.

Referring to FIG. 2, a mold 100 may include a first molding block 110 and a second molding block 120. The first molding block 110 may have a first surface 111 facing the second molding block 120. The first surface 111 may have: a first cavity 112; a second cavity 113; a first flow path 114; and a plurality of coupling holes 115.

The first cavity 112 has substantially the same shape as a first core pack 130, so as to receive the first core pack 130. The first core pack 130 is loaded in the first cavity 112. The second cavity 113 has substantially the same shape as a second core pack 140, so as to receive the second core pack 140. The second core pack 140 is loaded in the second cavity 113.

The first flow path 114 may extend from an inlet 114a formed on an edge of the first surface 111, so as to communicate with the first cavity 112 and the second cavity 113. The coupling holes 115 may be formed around the first cavity 112 and the second cavity 113. Bottoms of the coupling holes 115 may be smaller than openings of the coupling holes 115, to facilitate the coupling of the first molding block 110 and the second molding block 120.

The second molding block 120 may have a second surface 121 facing the first molding block 110. The second surface 121 may have: a third cavity 122; a fourth cavity 123; a second flow path 124; and a plurality of coupling protrusions 125.

The third cavity 122 has substantially the same shape as the first cavity 112. The third cavity 122 corresponds to the first cavity 112 of the first molding block 110. When brought together, the first and third cavities 112, 122 form a first chamber 126. The first core pack 130 is inserted in the first chamber 126.

The fourth cavity 123 has substantially the same shape as the second cavity 113. The fourth cavity 123 corresponds to the second cavity 113. When brought together, the second and fourth cavities 113, 123 form a second chamber 127. The second core pack 140 is inserted in the second chamber 127.

The second flow path 124 has substantially the same shape as the first flow path 114. When brought together, the first and second flow paths 114, 124 form a resin flow path 128. A molten resin is supplied to the first chamber 126 and the second chamber 127, via the resin flow path 128.

The coupling protrusions 125 correspond to the coupling holes 115 formed in the first molding block 110. When the coupling protrusions 125 are inserted and fixed to the coupling holes 115, the first molding block 110 and the second molding block 120 can be accurately coupled together. The coupling protrusions 125 may have tapered ends to facilitate the coupling of the first molding block 110 and the second molding block 120.

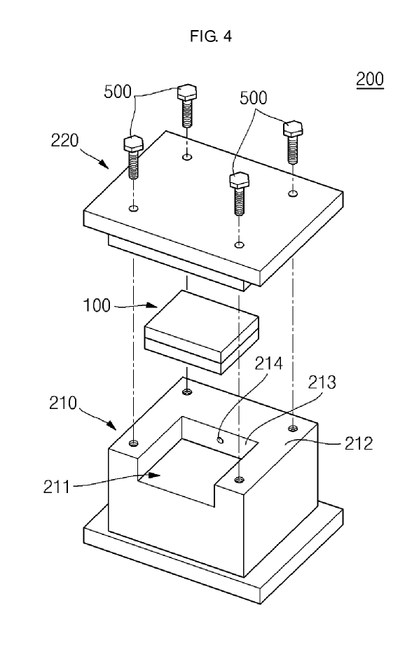

The mold 100 may be made of a plastic material that is insulating and lightweight. Therefore, it is possible to prevent a short circuit between the first and second core packs 130, 140 and at the same time, to facilitate the movement of the mold 100 to an injection molding apparatus 200 (FIG. 4). The mold 100 may be made of a thermosetting resin having a good heat resistance. The mold 100 may be made of a material that is resistant to temperatures of from about 140 to 150° C., such as Bakelite, or Teflon, considering that many generally used hot-melt resins have an injection temperature of about 140° C.

The mold 100 is shown as having the two chambers 126 and 127, but the present teachings are not limited thereto. For example, the mold 100 may have a single chamber, or three or more chambers.

The mold 100 is taught to be made of a plastic material, but the present teachings are not limited thereto. For example, the mold 100 may be made of a metal material. In this case, at least the chambers of such a mold may be coated with a resin, to prevent a short circuit between core packs.

The first core pack 130 may include a pouch-shaped bare cell 131 and a protection circuit module 132 connected to the bare cell 131. The bare cell 131 may be a lithium polymer battery. The protection circuit module 132 may include a charge/discharge switching device and a control integrated circuit to control the switching device. The protection circuit module 132 is responsible for controlling the charging/discharging of the bare cell 131. The second core pack 140 generally has the same structure as the first core pack 130.

The loading of the first and second core packs 130, 140 in the mold 100 will now be described with reference to FIG. 2. Referring to FIG. 2, the first core pack 130 is loaded in the first cavity 112, and the second core pack 140 is loaded in the second cavity 113.

Then, the first surface 111 of the first molding block 110 is positioned to face the second surface 121 of the second molding block 120. The coupling protrusions 125 are then inserted and fixed to the corresponding coupling holes 115, thereby coupling the first molding block 110 and the second molding block 120.

As such, the core packs 130, 140 are inserted and fixed in the mold 100, while the mold 100 is detached from an injection molding apparatus (refer to “200” in FIG. 4), thereby reducing the possibility that the core packs 130, 140 are misaligned and enhancing production speed. This differs from a conventional battery manufacturing method, wherein a core pack is directly inserted in a cavity formed in an injection molding apparatus.

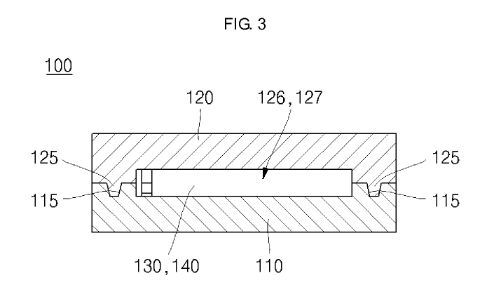

FIG. 3 is a sectional view of the mold 100, including the first and second core packs 130, 140 inserted therein. Referring to FIGS. 2 and 3, the first and second core packs 130, 140 are respectively inserted in the first and second chambers 126, 127. The coupling protrusions 125 are fitted into the coupling holes 115 of the first molding block 110, thereby enabling accurate coupling of the two molding blocks 110, 120.

Hereinafter, the loading of the mold 100 in an injection molding apparatus 200 (S20) will be described in detail with respect to FIG. 4. The injection molding apparatus 200 includes: a body 210 having a mold receiving portion 211, into which the mold 100 is detachably inserted; and a cover 220 disposed on the body 210. The cover 220 may be removably mounted on the body 210, so as to cover the body 210.

The body 210 may include a conventional molten resin injection device (not shown). The mold receiving portion 211 is formed at an upper side of the body 210. The mold receiving portion 211 may be formed in a top surface 212 of the body 200, for example. A molten resin supply hole 214 is formed in a sidewall 213 of the mold receiving portion 211. A molten resin injected from a nozzle (not shown) of the molten resin injection device is supplied to the resin flow path 128 (FIG. 2) of the mold 100, via the molten resin supply hole 214. The mold 100 is fixedly secured onto the mold receiving portion 211.

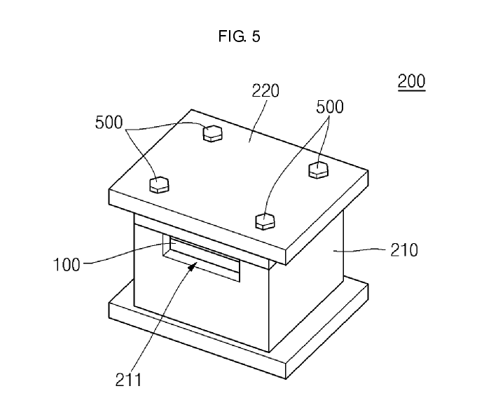

As shown in FIGS. 4 and 5, the mold 100 may be secured to the body 210 by various removable fastening member 500. For example, screws, clamps, or the like may be used as the removable fastening member 500. The resin flow path 128 is configured to communicate with the molten resin supply hole 214. As such, the mold 100 is loaded onto the mold receiving portion 211, thereby improving a battery production speed, as compared with a conventional injection molding apparatus, where a core pack is directly inserted in a cavity formed in a molding apparatus. Furthermore, even when the shape of a core pack inserted in a mold is undesirably changed, such a problem can be easily solved, by simply replacing the mold holding the problematic core pack. This allows for the standardization of the injection molding apparatus 200.

Hereinafter, the filling of the molten resin (S30) will be described with reference to FIG. 5. Referring to FIGS. 2-5, the mold 100 is loaded onto the mold receiving portion 211, and the body 210 is covered with the cover 220. In this state, a molten resin is injected into the chambers 126, 127 of the mold 100. The molten resin may be a hot-melt resin.

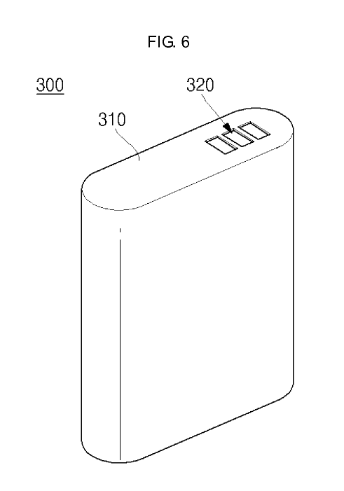

FIG. 6 illustrates a polymer secondary battery 300 produced by a battery manufacturing method, according to an exemplary embodiment of the present teachings. Referring to FIG. 6, the polymer secondary battery 300 may include a resin-molded portion 310. The resin-molded portion 310 may be formed from a molten resin (e.g., a hot-melt resin), using the injection molding apparatus 200. The resin-molded portion 310 surrounds the entire surface of the secondary battery 300, except for a charge-discharge terminal 320, so as to protect the bare cell 131 and the protection circuit module 132. According to some exemplary embodiments, the resin-molded portion 310 may be variously modified, so as to surround less of the bare cell 131, provided that it can fixedly connect the bare cell 131 and the protection circuit module 132.

According to aspects of the present teachings, a core pack is inserted in a mold that is detached from an injection molding apparatus. The mold is then loaded in the injection molding apparatus, thereby ensuring more accurate positioning of the core pack and an improved battery production speed. Furthermore, even when the shape of a core pack is undesirably changed, such a problem can be easily solved by simply replacing a mold holding the problematic core pack, with a new mold holding a desired core pack, thereby enabling more efficient use of an injection molding apparatus.

Furthermore, since a mold housing a core pack is loaded in an injection molding apparatus, a battery production speed can be significantly improved. Moreover, the use of a plastic mold enables easy movement of a large number of molds to desired positions and the prevention of a short circuit between core packs. In addition, the use of a mold made of a material suitable for a high temperature environment, e.g., Bakelite or Teflon, prevents deformations of the mold that may occur due to the use of a hot-melt resin.

Although a few exemplary embodiments of the present teachings have been shown and described, it would be appreciated by those skilled in the art that changes may be made in these exemplary embodiments, without departing from the principles and spirit of the present teachings, the scope of which is defined in the claims and their equivalents.

What is claimed is:

1. A method of manufacturing a secondary battery, the method comprising:
loading a core pack into a chamber of a mold;
loading the mold on a mold receiving portion of an injection molding apparatus; and
filling the chamber with a molten resin.

2. The method of claim 1, wherein the mold comprises a plastic material.

3. The method of claim 2, wherein the mold comprises a thermosetting resin.

4. The method of claim 1, wherein the mold comprises Bakelite or Teflon.

5. The method of claim 1, wherein the molten resin is a hot-melt resin.

6. The method of claim 1, wherein the core pack comprises a pouch-shaped bare cell and a protection circuit module connected to the bare cell.

7. The method of claim 1, wherein the loading of the core pack in the chamber of the mold comprises:
placing the core pack in a first cavity formed in a first molding block; and
coupling the first molding block to a second molding block having a second cavity corresponding to the first cavity .

8. The method of claim 7, wherein the coupling of the first molding block and the second molding block comprises inserting coupling protrusions extending from the second molding block into coupling holes formed in the first molding block.

9. The method of claim 1, wherein the mold has two or more chambers.

10. The method of claim 1, wherein the loading of the mold on the mold receiving portion comprises using a removable fastening member to secure the mold.

11. The method of claim 10, wherein the bare cell is a lithium polymer battery.

12. A secondary battery manufactured by the method of claim 1.

13. A method of manufacturing a secondary battery, the method comprising:
placing lithium polymer batteries and protection circuit modules in cavities of a first molding block;
coupling the first molding block to a second molding block having cavities corresponding to the cavities of the first molding block, thereby forming a mold;
loading the mold on a mold receiving portion of an injection molding apparatus; and
injecting a molten resin into the mold, so as to cover the core packs,
wherein the mold comprises Bakelite or Teflon.

14. The method of claim 13, wherein the injecting of the molten resin comprises injecting the molten resin into a resin flow path formed in the first and second molding blocks, which extends to the first and second cavities.

15. A secondary battery manufactured by the method of claim 13.
